(19) United States
(12) Patent Application Publication
(10) Pub. No.: US 2008/0242181 A1
(43) Pub. Date: Oct. 2, 2008

(54) DISPLAY DEVICE MANUFACTURING METHOD AND DISPLAY DEVICE PRODUCED THEREBY

(76) Inventor: Toshiro TAKAHASHI, Kanagawa (JP)

Correspondence Address: BIRCH STEWART KOLASCH & BIRCH, PO BOX 747, FALLS CHURCH, VA, 22040-0747, US

(21) Appl. No.: 12/053,726

(22) Filed: Mar. 24, 2008

(30) Foreign Application Priority Data
Mar. 30, 2007 (JP) 2007-090853

(51) Int. Cl. H01J 9/20

(52) U.S. Cl. 445/24

(57) ABSTRACT

A display device manufacturing method comprising: forming pixels 20 such that the pixels are disposed in an array in two intersecting directions on a flexible substrate 10; and forming terminals 14,18 for connecting the respective pixels that arrayed in the two intersecting directions on the flexible substrate with respective external lines, the terminals being formed so as to be in row(s) along the direction X with the smaller dimensional change ratio of the substrate, from the two directions on the flexible substrate.

### CROSS-REFERENCE TO RELATED APPLICATION

This application claims priority under 35 USC 119 from Japanese Patent Application No. 2007-90853, the disclosure of which is incorporated herein by reference.

### BACKGROUND OF THE INVENTION

1. Field of the Invention

The present invention relates to a manufacturing method for a display device, such as those using an organic electroluminescence element (organic EL element) or a liquid crystal element, and to a display device manufactured thereby.

2. Description of the Related Art

In recent years, flat panel display device including liquid crystal element, organic EL element or the like are widely used. FIG. 10 schematically shows the structure of an organic EL element 1. An anode 3, an organic EL layer 8 including a hole transporting layer 4, a light-emitting layer 5, and an electron transporting layer 6, a cathode 7, and others are formed on a substrate 2 made of, for example, glass. The electrodes 3 and 7 are connected with external lines via a lead line (terminal) 9. Upon application of an electric field to the electrodes 3 and 7, the region of the light-emitting layer 5 sandwiched between the electrodes 3 and 7 is excited to emit light

Generally, when displaying color, it is necessary to array plural pixels that include sub-pixels with different light-emitting colors to each other, such as red (R), green (G) and blue (B), on a substrate in two perpendicular directions, for example in columns and rows.

In order to manufacture a display device for color display using an organic EL element, for example, an anode in a stripe pattern may be formed on a substrate, and then organic coloring materials may be vapor deposited in sequence on the anode so as to form organic EL layers corresponding to RGB, the organic EL layers being exposed in a repeating pattern. A cathode may then be formed on the organic EL layers, and then external lines, such as control lines or signal lines, may be connected to each of the terminals of the electrode (external connecting terminals). Adjacent RGB organic EL layer portions that have been sandwiched between the electrodes each form sub-pixels, the sub-pixels together configure single pixels, and, as shown in FIG. 11, multiple pixels 74 including RGB sub-pixels are thereby arrayed in two directions, columns and rows, on a substrate 72.

Regarding such a substrate (substrate for display) on which pixels are formed, display devices have been proposed that use, instead of a glass substrate, a flexible substrate, such as a resin film or metal plate (see, for example, Japanese Patent Application Laid-Open (JP-A) No. 7-78690, JP-A No. 2002-15859, and JP-A No. 2004-361774). By the use of a flexible substrate that does not crack even when bent by a large degree, a display device with high impact resistance may be provided. In particular flexible substrates formed from a resin film have the merits of high transmittance and light weight.

With regard to the external lines, wiring boards 76, 78 are may be used, which generally have been formed with lines of copper or the like on a resin film, such as polyimide. Lines are formed with a predetermined pitch on the wiring boards 76, 78, so as to connect with the external connection terminals. An anisotropic conductive material (such as an anisotropic conductive film, ACF), which is an adhesive material in which conductive particles are dispersed, is disposed between a display board and a wiring board, and external connection terminals are electrically connected to external lines by alignment followed by heat and pressure bonding.

There are various methods proposed for pressure bonding, such as methods for rapid bonding by irradiation of a laser beam (see Japanese Patent Application Laid-Open (JP-A) No. 10-321265), and methods of applying adhesive separately to both a display board and a wiring board, and pressure bonding at room temperature (JP-A No. 2006-253665). However, influence on the display device during manufacture due to heating the substrate and due to the photolithography process, together with changes in the dimensions of the substrate before bonding due to moisture in the atmosphere during storage, are not considered conventionally.

If the amount of change in the dimensions of a flexible substrate before bonding is large, then, as shown in FIG. 12, the positions of each of the external connection terminals 80 of the electrodes may not match the external lines 82, and an inability to precision bond may occur.

### SUMMARY OF THE INVENTION

The present invention has been made in view of the above circumstances and provides the following display device manufacturing method, and a display device manufactured thereby.

A first aspect of the present invention provides a display device manufacturing method including: forming pixels such that they are disposed in an array in two intersecting directions on a flexible substrate; and forming terminals for connecting each of the pixels arrayed in the two intersecting directions on the flexible substrate, the terminals being formed so as to be disposed in row(s) along the direction with the smaller dimensional change ratio, from the two directions on the flexible substrate.

A second aspect of the present invention provides a display device manufacturing method including: a photolithographic process, patterning such that pixels are disposed in an array in two intersecting directions on a flexible substrate; and forming terminals for connecting each of the pixels arrayed in the two intersecting directions on the flexible substrate to respective external lines, the terminals being formed so as to be disposed in row(s) along the direction with the smaller dimensional change ratio between before and after the photolithographic process, from the two directions on the flexible substrate.

### BRIEF DESCRIPTION OF THE DRAWINGS

FIG. 1 is a schematic plan view showing an example arrangement of external connection terminals formed on a flexible substrate according to the present invention.

FIG. 2 is a schematic plan view showing a state in which light-emitting layers corresponding to RGB have been formed on an anode.

FIG. 3 is a schematic plan view showing a state in which a cathode has been formed on an organic EL layer.

FIG. 4 is a schematic plan view showing a state in which a wiring board has been pressure bonded to a display substrate.

FIG. 5 is a schematic view showing, according to the present invention, the positional relationship between external connection terminals that have been formed on a flexible substrate and external lines on a wiring board.

FIG. 6 is a schematic plan view showing another example of an arrangement of external connection terminals.

FIG. 7 is a schematic plan view showing a further example of an arrangement of external connection terminals.

FIG. 8 is a schematic view showing an example of pixels that have RGB sub-pixels arrayed in a stripe pattern (stripe-arrayed).

FIG. 9 is a schematic showing an example of a display configuration using color filters.

FIG. 10 is a schematic view showing an example of an organic EL element configuration.

FIG. 11 is a schematic plan view showing a general arrangement of a wiring board.

FIG. 12 is a schematic view showing misalignment between external connection terminals and external lines.

### DETAILED DESCRIPTION OF THE INVENTION

Explanation will be given below, with reference to the attached drawings, of manufacturing a display device with an organic EL element.

Generally, in order to improve the mechanical strength, dimensional stability and heat stability, biaxially oriented films that have been stretched in two orthogonal directions are used for such a film substrate in such display devices, since there is directionality of the rigidity and extendibility when uniaxially oriented resins are used, such as films of PEN (polyethylene naphthalate) or PET (polyethylene terephthalate). This means that no particular consideration is given to the substrate orientation when such biaxial stretched films are used as flexible substrates when manufacturing display elements conventionally.

However, biaxially oriented films are formed into a film shape by a roll-to-roll (R to R) process, and so the force that is applied thereto is not the same in the longitudinal and lateral directions, and so the dimensional stability and heat stability of the films do in fact depend on the axial direction. The inventors' research has revealed that when manufacturing display device using flexible substrates, even if, for example, a 200 mm×200 mm biaxially oriented film is used as such a substrate, the dimensions of the substrate change due to heating in the patterning process, or due to solvents in a photolithographic process, and a difference of the order of 200 μm may occur in the extension depending on the axial direction.

On the other hand, when pixels are arrayed on the substrate with side lengths of several tens of μm to several hundreds of μm, the width and pitch of terminals that are connected to such small pixels are also of the order of μm. Therefore, the slightest difference in the dimensional change ratio of the substrate has a great influence on the connection of terminals and external lines.

With respect to this, the inventors have considered such a difference in the dimensional change ratio of the flexible substrate, and discovered that when manufacturing a display device, the positional precision may be improved for pressure bonding external connection terminals to external lines by forming the terminals for connecting each of the pixels, which have been arrayed in two intersecting directions on the flexible substrate, to each of external lines, so that the connection terminals are disposed in row(s) along the direction with the smaller dimensional change ratio, from the two directions on the flexible substrate.

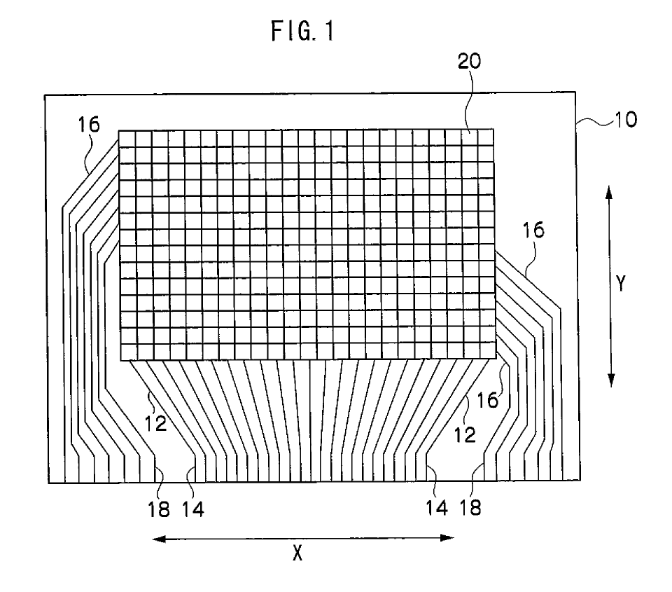

An example is shown in FIG. 1 of an arraying pixels 20, lead lines 12, 16, and terminals 14, 18 that have been formed on a flexible substrate resin film substrate 10. Plural of the pixels 20 are arrayed in the horizontally and vertically directions X and Y on the substrate 10, and lead lines 12, 16 are formed for each column and row pixel line in the area surrounding the pixels. There are the terminals 14, 18 formed to the leading ends of each of the lead lines 12, 16, for connecting to external lines, and each of the external connection terminals 14, 18 are formed so as to be disposed in a row along the X direction, which is the direction with the smaller dimensional change ratio for the substrate 10, from the two directions on the substrate 10 in which the pixels 20 have been arrayed.

<Substrate>

For a substrate 10 for use in the present invention, a flexible substrate that is capable of being used as a substrate in display devices may be used without any particular limitation thereto, and the following, for example, may be used: biaxially oriented resin films, such as polyesters composed of polyethylene terephthalate, polybutylene phthalate, polyethylene naphthalate, or the like; polystyrene, polycarbonate, polyethersulfone, polyarylate, polyimide, polycycloolefins, norbornene resin, and poly (chlorotrifluoroethylene). Film substrates such as the above have high transmission characteristics and rigidity, and may be appropriately applied as display device substrates.

The thickness of such a flexible substrate may be determined according to such factors as the purpose of use of the display device. However, considering characteristics of a display device substrate, such as the rigidity, transmission characteristics and flexibility, the thickness is preferably from 50 μm to 3 mm, with 100 μm to 300 μm being more preferable.

Furthermore, gas barrier coats for preventing the permeation of moisture and oxygen, hard coat layers for preventing scratching of the organic EL element, and undercoat layers for improving the flatness and anode adhesion, may be appropriately used on such resin flexible substrates.

<Organic EL Element>

An organic EL element is formed that includes light-emitting layers on the substrate 10 such as described above. It should be noted that there are no particular limitations to the display method of the display device according to the present invention, as long as pixels 20 may be arrayed in two intersecting directions on a substrate 10, and various method may be used therefore, such as a separate patterning process (color light-emission method), a color filter method, or a color conversion method. The following explanation will mainly relate to forming an organic EL element by a coating separation method.

There are no particular limitations to the layer configuration of such an organic EL element, and the configuration thereof may be appropriately determined according to the purpose of use. Explanation is given below with respect to the following layer configuration, however, the present invention is not limited thereto.

Anode/light-emitting layer/cathode

Anode/hole transporting layer/light-emitting layer/electron transporting layer/cathode

Anode/hole transporting layer/light-emitting layer/blocking layer/electron transporting layer/cathode

Anode/hole transporting layer/light-emitting layer/blocking layer/electron transporting layer/electron injecting layer/cathode

Anode/hole injecting layer/hole transporting layer/light-emitting layer/blocking layer/electron transporting layer/cathode

Anode/hole injecting layer/hole transporting layer/light-emitting layer/blocking layer/electron transporting layer/electron injecting layer/cathode

<Anode>

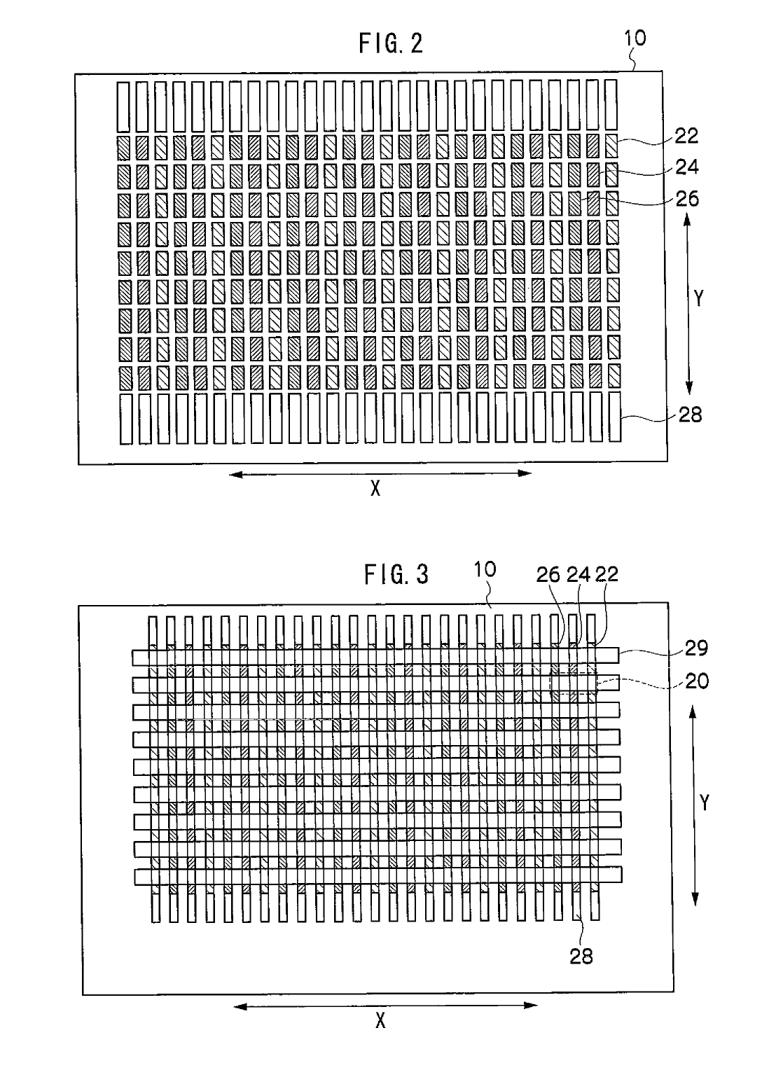

The anode, lead lines 12 and the external connection terminals 14 are first formed on the substrate 10. Well known anode materials may be suitably used for the anode, such as, for example, conductive metal oxides like antimony or fluorine doped tin oxide (ATO, FTO), tin oxide, zinc oxide, indium oxide, indium tin oxide (ITO), indium zinc oxide (IZO), aluminum and gallium doped zinc oxide (AZO, GZO). After vapor depositing over the whole of the substrate 10, using sputtering vapor deposition with materials such as these, patterning of the anode, lead lines 12 and external connection terminals 14 may be performed using photolithography. When performing such patterning, as shown in FIG. 2, an anode 28 is formed in a striped pattern, and the external connection terminals 14 are arrayed on the substrate 10 in a row along the direction on the substrate 10 with the smaller dimensional change ratio, from the two intersecting directions X and Y of pixel array on the substrate 10.

In this respect, the dimensional change ratio of the film substrate 10 may be determined according to factors such as the temperatures to which the film substrate 10 will be exposed during depositing electrode materials and organic layers as described later. Therefore, for example, the dimensional change ratio may be determined based on the difference in the dimensions of the film substrate 10 at a temperature close to the temperature during the deposition, from the dimensions of the film substrate 10 at room temperature. Specifically, the substrate dimensions in the longitudinal and lateral directions of the flexible substrate for measurement are measured at 20° C. and 80° C. (L₂₀, L₈₀), and by calculating the dimensional change ratio (an absolute value) as expressed by (L₈₀−L₂₀)/L₂₀, the direction of larger dimensional change ratio (a first direction) and the direction of smaller dimensional change ratio (a second direction) may be established in advance. After establishing the direction of larger dimensional change ratio of the film substrate 10 in such a manner, flexible substrates that have been manufactured in the same manner as the substrate used for measurement may be used, and external connection terminals for the anode and the like may be formed in the predetermined direction on the substrate.

It should be noted that the lead lines 16 and the terminals 18 for the cathode, may be formed at the same time as the above patterning of the anode 28 and the anode terminals 14. For example, sputtering deposition may be carried out to the whole substrate surface using ITO or the like, and patterning performed for the lead lines 12, 16, and the external connection terminals 14, 18 as well as for the anode 28. In such a case, the cathode terminals 18 are also formed in row(s) along the X direction that is the direction with the smaller dimensional change ratio, from the two intersecting directions X and Y of arraying the pixels 20.

<Organic EL Layer>

After the anode has been formed, an insulating layer and dividing walls are formed, and then an organic EL layer including light-emitting layer(s) is formed. There are no particular limitations to factors such as the configuration of layer(s), thickness, and materials for the organic EL layer, as long as light-emitting layer(s) are included, and light emission of a predetermined color is displayed on application of a voltage. Well known layer configurations, materials and the like may be employed for the organic EL layer.

The light-emitting layer may, for example, include at least one type of light-emitting material, and hole transporting materials, electron transporting materials and/or host materials may be included as required. There are no particular limitations to the light-emitting materials, and both fluorescent light-emitting materials and phosphorescent light-emitting materials may be used.

Examples that may be given of fluorescent light-emitting materials include, for example, benzoxazole derivatives, benzimidazole derivatives, benzothiazole derivatives, styrylbenzene derivatives, polyphenyl derivatives, diphenylbutadiene derivatives, tetraphenylbutadiene derivatives, naphthalimide derivatives, coumarin derivatives, perylene derivatives, perinone derivatives, oxadiazole derivatives, aldazine derivatives, pyralidine derivatives, cyclopentadiene derivatives, bis-styrylanthracene derivatives, quinacridone derivatives, pyrrolopyridine derivatives, thiadiazolopyridine derivatives, styrylamine derivatives, aromatic dimethylidine compounds, various metal complexes, typified by metal complexes and rare earth complexes of 8-quinolinol derivatives, and polymer compounds such as polythiophene derivatives, polyphenylene derivatives, polyphenylene vinylene derivatives, and polyfluorene derivatives. These materials may used singly, or in combinations of two or more thereof.

There are no particular limitations to phosphorescent light-emitting materials, but orthometalated metal complexes or porphyrin metal complexes are preferable. There are various ligands that may be used for forming the above orthometalated metal complexes, and examples that may be given of preferable ligands include 2-phenylpyridine derivatives, 7,8-benzoquinoline derivatives, 2-(2-thienyl) pyridine derivatives, 2-(1-naphthyl) pyridine derivatives, and 2-phenyl quinoline derivatives. These derivatives may be substituted as required. Furthermore, the above orthometalated metal complexes may include the above ligands together with other ligands.

Platinum porphyrin complexes are preferable porphyrin metal complexes.

Phosphorescent light-emitting materials may be used singly, or in combinations of two or more. Furthermore, fluorescent light-emitting materials and phosphorescent light-emitting materials may be used together.

A hole transporting layer or the like may be formed, as required, on the anode 28, and then light-emitting layers corresponding to RGB are formed in sequence using a mask (shadow mask) in which holes (apertures) are formed therein according to the size of the RGB sub-pixels. In this manner, as shown in FIG. 2, light-emitting layers 22, 24, 26 that correspond to RGB may be formed on the anode 28 by carrying out mask deposition in sequence for each of R, G and B. It should be noted that the formation method of each of the light-emitting layers 22, 24, 26 is not limited to mask deposition such as above, and, for example, an inkjet method, printing method, or mold transfer method may also be employed.

After the light-emitting layers 22, 24, 26 corresponding to RGB have been formed, an electron transporting layer or the like may be formed as required.

Also, when forming the organic EL layer by the above mask deposition, as the substrate 10 is heated, there is usually a gradual increase in the dimension in the column and row directions, and there is thereby a change in the separation of each of the external connection terminals 14 formed on the substrate 10. However, each of the terminals 14 are formed in row(s) along the X direction that is the direction with the smaller dimensional change ratio on the substrate 10 from the two directions X and Y of pixels 20 array on the substrate 10, and therefore the influence of dimensional change in the substrate 10 during processing may be suppressed.

<Cathode>

After the organic EL layer including the light-emitting layers has been formed, a cathode 29 may be formed in a striped pattern and orthogonal to the anode 28, for example, as shown in FIG. 3. There are no particular limitations to the material for configuring the cathode 29, and the cathode 29 may be formed by vapor deposition using well known materials, such as Al, MgAg, AlLi. Specifically, mask deposition may be performed to the region in which the cathode 29 and the like are to be formed, and the cathode 29 may be formed in a striped pattern in a direction that is orthogonal to the anode 28 at the same time as forming the lead lines 16 and the external connection terminals 18 for the cathode. When doing so, the cathode terminals 18, in the same manner as the anode terminals 14, are formed in row(s) along the X direction which is the direction with the smaller dimensional change ratio on the substrate 10 from the two directions X and Y of pixels 20 array on the substrate 10. It should be noted that when external connection terminals 18 and the like for the cathode have already been formed when forming the anode as described above, patterning may be performed such that the cathode 29 connects with the external connection terminals 18 via the lead lines 16.

By forming the cathode 29 and the like in the above manner, the organic EL elements, which include the adjacent light-emitting layers 22, 24, 26 corresponding to RGB and sandwiched between the two electrodes 28, 29, each become respective sub-pixels, and these sub-pixels together configure single pixels 20. In this manner, the plural pixels 20 that include the RGB sub-pixels are arrayed orthogonally on the substrate 10 in column and row directions.

<Sealing Member and the Like>

After the cathode 29 has been formed, the configuration may be covered with a sealing member (protection layer), in order to suppress deterioration of the organic EL element due to moisture and oxygen. Materials such as glass, metals, and plastics may be used as the sealing member.

<External Lines>

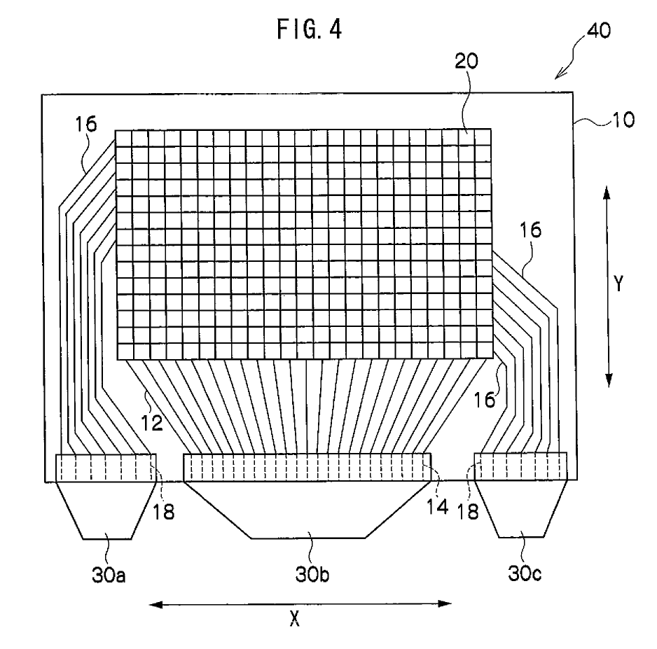

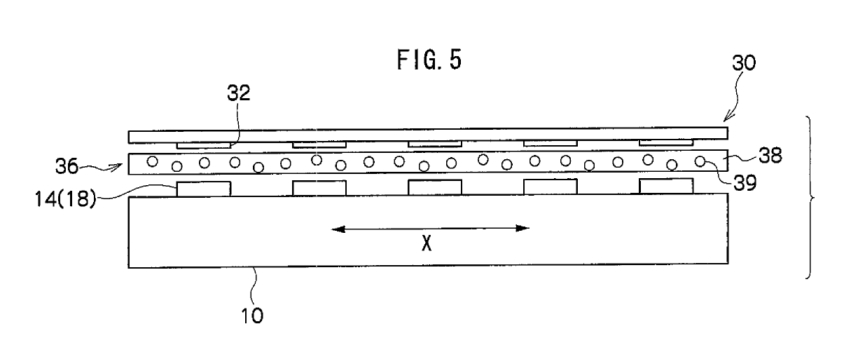

After sealing, for example as shown in FIG. 4, the wiring boards 30a, 30b, 30c on which the external lines, such as control lines and signal lines, have been formed, are positionally aligned with the external connection terminals 14, 18 that are disposed in a row along the edge of the substrate 10, and then pressure bonded. The wiring boards 30a, 30b, 30c may employ, for example, a wiring board that is a film substrate of a flexible substrate, such as a substrate of polyimide or polyester, on which lines have been formed in advance, by plating Cu or the like on the substrate 10, at a width and pitch that correspond to those of the terminals 14, 18. Even if the display substrate 10 changes in dimension due to heat during vapor deposition or due to solvents during photolithography, since the respective terminals 14, 18 of the two electrodes are formed in a row along the direction of smaller dimensional change ratio of the substrate 10, any misalignment from their design positions is small. Therefore, as shown in FIG. 5, the external connection terminals 14, 18 on the display substrate 10 and external lines 32 on a wiring board 30 may be positioned with high alignment precision, an ACP (anisotropic conductive paste) or an ACF (anisotropic conductive film), formed from an anisotropic conductive material 36 in which conductive particles 39 such as of Ni have been dispersed in an adhesive 38, is applied between the display substrate 10 and the wiring board 30 and then these are heat and pressure bonded together. By so doing, a display device 40 may be manufactured with each of the electrode terminals 14, 18 and the external lines 32 bonded together with good precision. Therefore, by application of the present invention, the quality and yield may be reliably improved when carrying out continuous production of organic EL display devices.

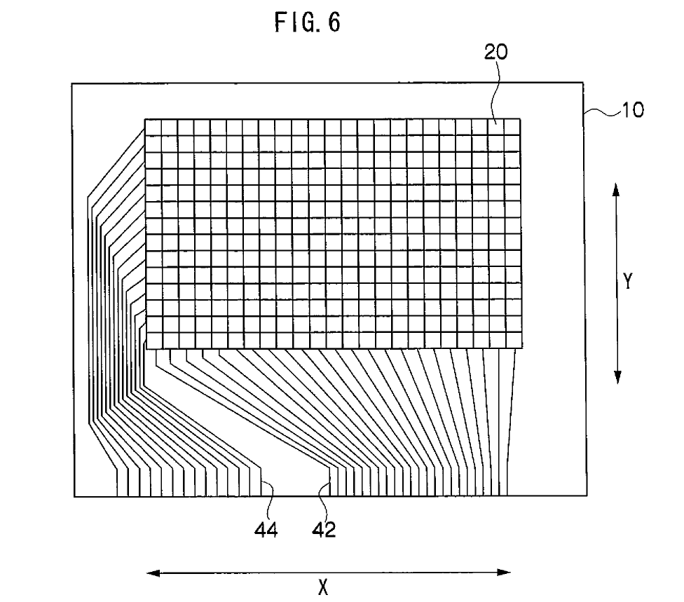

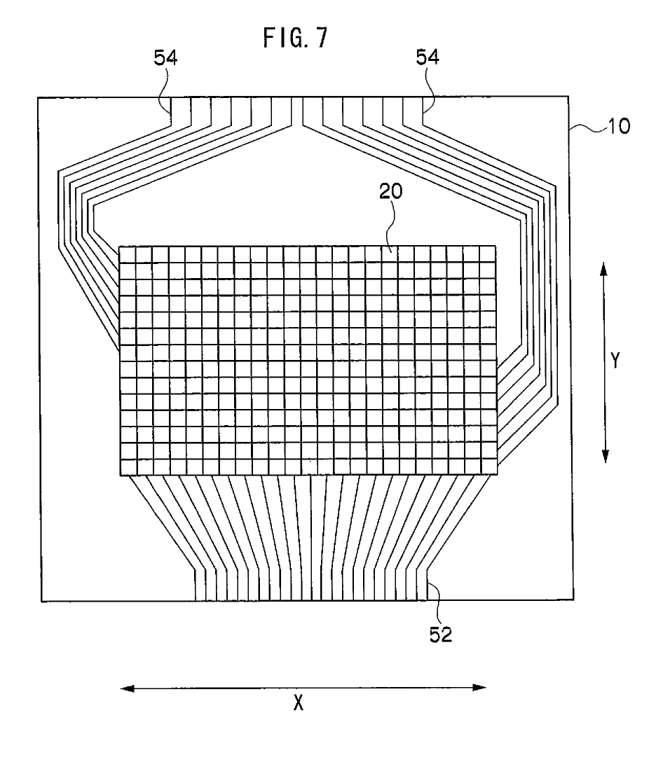

It should be noted that there is no limitation of the array for the external connection terminals 14, 18 for the two electrodes to the array as shown in FIG. 1, and there is simply the requirement that the external connection terminals 14, 18 should be formed in row(s) along the direction with the smaller dimensional change ratio of the display substrate 10 of the two directions X and Y in which the pixels 20 are arrayed on the substrate 10. In other words, if the dimensional change ratio of the substrate 10 in the X direction is the smaller, the external connection terminals for both of the electrodes may be disposed in a row along the X direction, or, for example, as shown in FIG. 6, patterning may be carried out such that the external connection terminals 42, 44 for the two electrodes are disposed in a row along the same side of the substrate 10, the side divided so that about half is for external connection terminals 42 and half is for external connection terminals 44, or patterning may be carried out, as shown in FIG. 7, such that the external connection terminals 52, 54 for the two electrodes disposed in rows that are along opposite sides of the substrate 10.

There no particular limitations to such factors as the shape, array and configuration of the pixels, and, for example, other than a vertical striped array configured with RGB sub-pixels, a horizontal array or a delta array are suitable, or white (W) sub-pixels may be included in addition to the RGB sub-pixels within the single pixels.

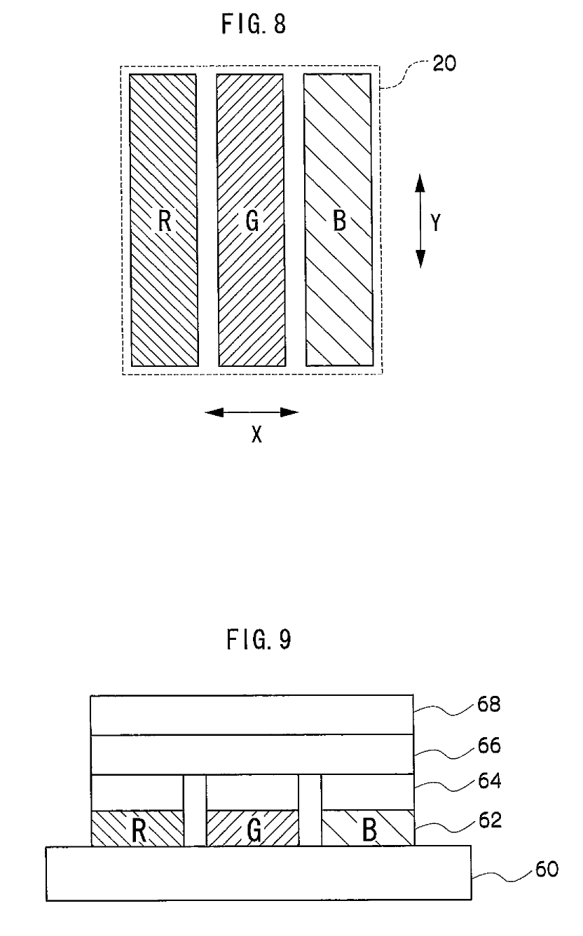

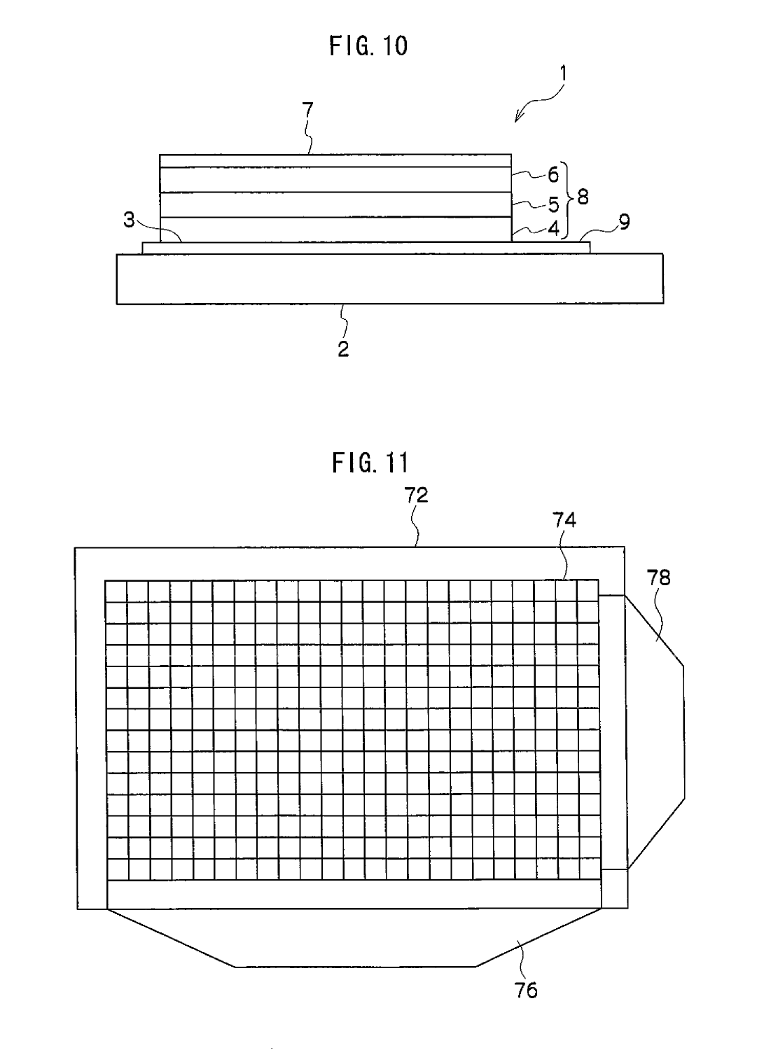

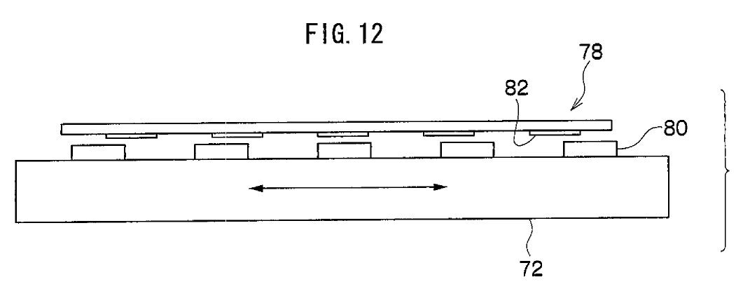

Furthermore, in the case of a simple matrix organic EL display device, as shown in FIG. 8, patterning is preferably performed such that the length direction of the pixels 20 is the same direction as the direction Y with the larger dimensional change ratio, since positional precision of the pixels may be improved thereby.

<Color Filter Method>

Explanation has been given above of an example of separate patterning process using mask deposition for the light-emitting layers corresponding to the each of the light emitting colors, however, a color filter method or a color conversion method may also be employed.

In the case of a color filter method, for example, as shown in FIG. 9, patterning may be carried out by photolithography so that color filters 62 corresponding to RGB are disposed in rows on a flexible substrate 60, and an anode 64, and an organic EL layer 66 including a light-emitting layer (white), and a cathode 68 are formed in sequence thereon. Such a photolithographic process includes such processes as coating, light exposure, alkali development, resist removal using a solvent, and dimensional changes readily occur to a film substrate during such a photolithographic process.

With regard to this, when patterning of the pixels on the flexible substrate includes carrying out a photolithographic process, it is preferable for the external connection terminals for the two electrodes to be formed so as to be disposed in row(s) along the direction with the smaller dimensional change ratio of the substrate 60 between before and after the photolithographic process, of the two intersecting directions on the substrate in which the pixels are arrayed. In other words, using the dimensional change ratios of the substrate between before and after the photolithographic process as a reference, by forming the external connection terminals for the two electrodes so that they are in row(s) along the direction with the smaller dimensional change ratio of the substrate, misalignment with the design positions for each of the terminal may be suppressed, and the terminals may be positionally aligned with high precision to the external lines.

<Liquid Crystal Displays>

Explanation has been given above to a case when manufacturing an organic EL display device, however the present invention may be suitably employed to the manufacture of display devices using liquid crystal elements.

When manufacturing liquid crystal display devices, generally a color filter method is employed and a photolithographic process is included. In such a case, the external connection terminals should be formed so as to be in row(s) along the direction with the smaller dimensional change ratio of the substrate between before and after the photolithographic process, of the two directions on the substrate in which the pixels are arrayed. By so doing, the misalignment of each of the external connection terminals from their design positions may be suppressed, and each of the terminals may be reliably positionally aligned with the external lines, enabling the manufacture of liquid crystal display devices with high precision displays.

The present invention has been explained above, however, the present invention is not limited to the above embodiment.

For example, the flexible substrate is not limited to biaxially oriented films, and film substrates that have been formed by another manufacturing method may be used.

Furthermore, the present invention may be applied, for example, to the manufacture of display devices such as organic EL display devices that are provided with multiphoton emission elements of plural stacked organic EL layers, and other display devices that use inorganic EL elements, plasma elements, or electric migration elements.

There is also no limitation to the method of electrical driving, and the present invention may be applied both to passive matrix display devices and to active matrix display devices. The display device is also not limited to full-color displays, and the present invention may also be applied to the manufacture of, for example, area-color displays. The present invention may also be applied to both double sided display devices and single sided display devices.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

All publications, patent applications, and technical standards mentioned in this specification are herein incorporated by reference to the same extent as if each individual publication, patent application, or technical standard was specifically and individually indicated to be incorporated by reference.

What is claimed is:

1. A display device manufacturing method comprising: forming pixels such that the pixels are disposed in an array in two intersecting directions on a flexible substrate; and forming terminals for connecting the respective pixels arrayed in the two intersecting directions on the flexible substrate with respective external lines, the terminals being formed so as to be in row(s) along the direction with the smaller dimensional change ratio of the substrate, from the two directions on the flexible substrate.

2. A display device manufacturing method comprising: a photolithographic process, patterning such that pixels are disposed in an array in two intersecting directions on a flexible substrate; and forming terminals for connecting the respective pixels arrayed in the two intersecting directions on the flexible substrate with respective external lines, the terminals being formed in row(s) along the direction with the smaller dimensional change ratio of the substrate between before and after the photolithographic process, from the two directions on the flexible substrate.

3. The display device manufacturing method of claim 1, wherein the pixels are formed such that the length direction of the pixels is the same direction as the direction with the larger dimensional change ratio.

4. The display device manufacturing method of claim 2, wherein the pixels are formed such that the length direction of the pixels is the same direction as the direction with the larger dimensional change ratio.

5. The display device manufacturing method of claim 1, wherein the dimensional change ratio of the substrate is the thermal dimensional change ratio of the substrate.

6. The display device manufacturing method of claim 2, wherein the dimensional change ratio of the substrate is the thermal dimensional change ratio of the substrate.

7. The display device manufacturing method of claim 3, wherein the dimensional change ratio of the substrate is the thermal dimensional change ratio of the substrate.

8. The display device manufacturing method of claim 4, wherein the dimensional change ratio of the substrate is the thermal dimensional change ratio of the substrate.

9. The display device manufacturing method of claim 1, wherein the pixels are formed comprising a plurality of sub-pixels with different colors of light emission.

10. The display device manufacturing method of claim 2, wherein the pixels are formed comprising a plurality of sub-pixels with different colors of light emission.

11. The display device manufacturing method of claim 7, wherein the pixels are formed comprising a plurality of sub-pixels with different colors of light emission.

12. The display device manufacturing method of claim 8, wherein the pixels are formed comprising a plurality of sub-pixels with different colors of light emission.

13. The display device manufacturing method of claim 1, wherein the pixels are formed from organic EL elements.

14. The display device manufacturing method of claim 2, wherein the pixels are formed from organic EL elements.

15. The display device manufacturing method of claim 11, wherein the pixels are formed from organic EL elements.

16. The display device manufacturing method of claim 12, wherein the pixels are formed from organic EL elements.

17. A display device manufactured according to the method of claim 1.

18. A display device manufactured according to the method of claim 2.

19. A display device manufactured according to the method of claim 15.

20. A display device manufactured according to the method of claim 16.
